(19) United States
(12) Patent Application Publication
(10) Pub. No.: US 2022/0351113 A1
(43) Pub. Date: Nov. 3, 2022

(54) PRODUCTION MANAGEMENT SYSTEM AND PRODUCTION MANAGEMENT METHOD

(71) Applicant: Hitachi, Ltd., Tokyo (JP)

(72) Inventors: Shimpei NISHIDA, Tokyo (JP); Hiroshi FUJII, Tokyo (JP); Satoshi TORIKAI, Tokyo (JP); Yuuichi SUGINISHI, Tokyo (JP)

(21) Appl. No.: 17/687,830

(22) Filed: Mar. 7, 2022

(30) Foreign Application Priority Data
Apr. 28, 2021 (JP) 2021-076578

(51) Int. Cl. G06Q 10/06; G06Q 10/08

(52) U.S. Cl. CPC G06Q 10/06395; G06Q 10/083; G06Q 10/06312

(57) ABSTRACT

The production management system includes: a first storage unit which stores actual production information including actual production values of the production of products in the production facility; a second storage unit which stores status information indicating a status of the production facility; a third storage unit which stores master information including a first threshold for detecting an abnormality in the production of products in the production facility; a calculation unit which calculates a correction term according to the status of the production facility based on the status information, and calculates a second threshold in which the calculated correction term is set to a first threshold included in the master information stored in the third storage unit; and a detection unit which detects an abnormality in the production of products in the production facility by using the actual production value included in the actual production information and the second threshold.

### CROSS-REFERENCE TO RELATED APPLICATION

The present application claims priority from Japanese application JP 2021-076578, filed on Apr. 28, 2021, the contents of which is hereby incorporated by reference into this application.

### TECHNICAL FIELD

The present invention generally relates to a technology of managing the production of products.

### BACKGROUND ART

When there is a deviation between the plan and the actual production of a certain product, an administrator retroactively examines the production process of that product in order to identify the cause of the deviation. Nevertheless, since there are branching of processes, merging of processes and common lines in the production process of products, the administrator needs to spend many man-hours to identify the cause. With respect to this point, disclosed is a production management system which compares actual production information including actual production values for each product and reference information including reference values for each product, calculates a deviation of the actual production value from the reference value, and outputs an alert when the calculated deviation is not within a range of a monitoring threshold (see PTL 1). According to the foregoing production management system, it is possible to easily identify the cause of the deviation.

### CITATION LIST

### Patent Literature

[PTL 1] Japanese Unexamined Patent Application Publication No. 2014-197308

### SUMMARY OF THE INVENTION

### Problems to be Solved by the Invention

With the production management system described in PTL 1, since there are cases where consideration is not given to the status of the actual production site (production facility), the administrator may not be able to identify a necessary cause or may identify an unnecessary cause as a result of the alert not being appropriately output.

The present invention was devised in view of the foregoing points, and an object of this invention is to propose a production management system and a production management method capable of outputting an alert according to the status of the production facility which produces products.

### Means to Solve the Problems

In order to achieve the foregoing object, the present invention provides a production management system which manages production of products in a production facility, comprising: a first storage unit which stores actual production information including actual production values of the production of products in the production facility; a second storage unit which stores status information indicating a status of the production facility; a third storage unit which stores master information including a first threshold for detecting an abnormality in the production of products in the production facility; a calculation unit which calculates a correction term according to the status of the production facility based on the status information stored in the second storage unit, and calculates a second threshold in which the calculated correction term is set to a first threshold included in the master information stored in the third storage unit; and a detection unit which detects an abnormality in the production of products in the production facility by using the actual production value included in the actual production information stored in the first storage unit and the second threshold calculated by the calculation unit according to the status of the production facility.

With the configuration described above, since a second threshold set with a correction term according to the status of the production facility is used and an abnormality in the production of products in the production facility is thereby detected, for example, it is possible to appropriately output an alert according to the status of the production facility.

### Advantageous Effects of the Invention

According to the present invention, it is possible to manage the production of products according to the status of the production facility.

### BRIEF DESCRIPTION OF DRAWINGS

FIG. 1 is a diagram showing an example of the configuration of the production management system according to the first embodiment.

FIG. 2 is a diagram showing an example of the configuration of the actual production visualization system according to the first embodiment.

FIG. 3 is a diagram showing an example of the actual production information according to the first embodiment.

FIG. 4 is a diagram showing an example of the 4M information according to the first embodiment.

FIG. 5 is a diagram showing an example of the production plan information according to the first embodiment.

FIG. 6 is a diagram showing an example of the master information according to the first embodiment.

FIG. 7 is a diagram showing an example of the external factor information according to the first embodiment.

FIG. 8 is a diagram showing an example of the threshold information according to the first embodiment.

FIG. 9 is a diagram showing an example of the lead time according to the first embodiment.

FIG. 10 is a diagram showing an example of the threshold setting processing according to the first embodiment.

FIG. 11 is a diagram showing an example of the lead time threshold calculation processing according to the first embodiment.

FIG. 12 is a diagram showing an example of the backlog correction term calculation processing according to the first embodiment.

FIG. 13 is a diagram showing an example of the material arrival delay correction term calculation processing according to the first embodiment.

FIG. 14 is a diagram showing an example of the downtime correction term calculation processing according to the first embodiment.

FIG. 15 is a diagram showing an example of the threshold candidate calculation processing according to the first embodiment.

FIG. 16 is a diagram showing an example of the operational availability threshold calculation processing according to the first embodiment.

FIG. 17 is a diagram showing an example of the monitoring processing according to the first embodiment.

### DESCRIPTION OF EMBODIMENTS

### (I) First Embodiment

An embodiment of the present invention is now explained in detail. Nevertheless, the present invention is not limited to the following embodiment.

With the production management system of this embodiment, a threshold is calculated by adding a correction term indicating the status of the production facility to the initial threshold, and an alert is output when the actual production value exceeds the threshold calculated according to the status of the production facility.

According to the foregoing configuration, for example, it is possible to appropriately output an alert according to the status of the production facility.

Here, in cases where the specific measurement index (KPI: Key Performance Indicator) of the goal attainment level is the lead time, when there is any backlog, since the production of backlog will also be performed, it is necessary to perform the production based on a tolerant time axis (first time which is a time that is longer than the time of the initial plan). Nevertheless, since a conventional production management system does not give consideration to the production of backlog, an alert is output before the lapse of the first time. Note that the term “lead time” is the time required for producing one product, and is the time that can be obtained by subtracting the production start time from the production end time.

With respect to this point, the production management system of this embodiment, for example, calculates a lead time of a new plan by performing scheduling for producing the products and backlog of the current day, and calculates the correction term of each product based on the lead time of the initial plan and the lead time of the new plan. It is thereby possible to output an alert by giving consideration to the backlog.

Moreover, when the KPI is the lead time, there are cases where the arrival of materials is delayed, and it is necessary to perform the production based on a tolerant time axis (second time which is a time that is longer than the time of the initial plan). Nevertheless, since a conventional production management system does not give consideration to the delay in the arrival of materials, an alert is output before the lapse of the second time.

With respect to this point, the production management system of this embodiment, for example, calculates the correction term of each process (for example, acquires the mode value from the distribution of the material arrival delay time) from the actual production information of the delay in the arrival of materials in each process. It is thereby possible to output an alert by giving consideration to the delay in the arrival of materials.

Moreover, when the KPI is the lead time, since there are cases where downtime such as the time between shifts (in-between time), break time, and machine maintenance time overlaps with the production time, it is necessary to perform the production based on a tolerant time axis (third time which is a time that is longer than the time of the initial plan). Nevertheless, since a conventional production management system does not give any consideration to the downtime, an alert is output before the lapse of the third time.

With respect to this point, when the plan (initial plan or new plan) overlaps with the downtime, the production management system of this embodiment, for example, uses the downtime as the correction term. It is thereby possible to output an alert by giving consideration to the downtime.

Moreover, in cases where the KPI is the lead time, when setting a threshold upon adding the correction term to the initial threshold, there may be cases where an unfeasible small threshold is set.

With respect to this point, when the threshold is smaller than a minimum value of the past lead time, the production management system of this embodiment, for example, sets the minimum value of the past lead time. It is thereby possible to avoid an unfeasible threshold from being set.

Moreover, in cases where the KPI is the operational availability, while the tolerance level of the operational availability will change depending on the production season (off season, normal season, or busy season), when the status of the production facility changes on a daily basis due to multiproduct production, since a conventional production management system does not give any consideration such change, an alert cannot be appropriately output.

With respect to this point, the production management system of this embodiment, for example, identifies the production season based on the past production quantity and the planned production quantity, and sets a threshold according to the production season. It is thereby possible to output an alert by giving consideration to the production season. Note that the term “operational availability” is the ratio of the time that the production facility is operating normally relative to a predetermined time.

An embodiment of the present invention is now explained with reference to the appended drawings. The following descriptions and drawings are exemplifications for explaining the present invention, and certain descriptions are omitted or simplified as needed for clarifying the explanation of the present invention. The present invention can also be worked in other various modes. Unless specifically limited herein, each constituent element may be singular or plural.

Note that, in the following explanation, the same reference numeral is assigned to the same element in the drawings, and any redundant explanation will be omitted. Moreover, when the same types of elements are explained without being differentiated, the common part (part excluding the branch number) of the reference code including the branch number will be used, and when the same types of elements are explained by being differentiated, the reference code including the branch number may be used. For example, when the production facility are explained without being differentiated, they will be indicated as “production facility 131”, and when the individual production facility are explained by being differentiated, they may be indicated as “production facility 131-1”, “production facility 131-2” and so on.

Expressions such as “first”, “second”, “third” and the like in the present specification and the drawings are affixed for identifying the constituent elements, and are not necessarily limited to quantity or order. Moreover, the numbers used for identifying the constituent elements are used for each context, and a number used in one context may not necessarily refer to the same configuration in another context. Moreover, a constituent element identified with a certain number is not precluded from concurrently serving the function of a constituent element identified with another number.

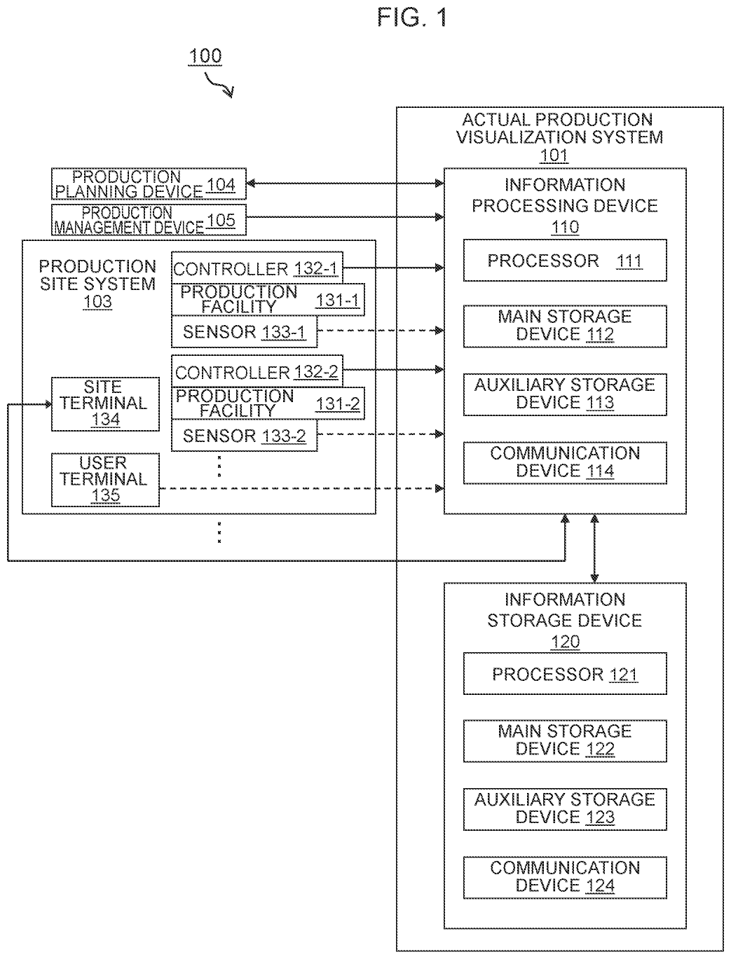

In FIG. 1, reference numeral 100 depicts the overall production management system according to the first embodiment.

FIG. 1 is a diagram showing an example of the configuration of the production management system 100.

The production management system 100 is configured by including an actual production visualization system 101, a production site system 103, a production planning device 104, and a production management device 105. The actual production visualization system 101 is connected communicably with each of the production site system 103, the production planning device 104 and the production management device 105 via a network, or without going through a network.

The actual production visualization system 101 is a system which visualizes the actual production in the production site system 103. More specifically, the actual production visualization system 101 is configured by including an information processing device 110 and an information storage device 120.

The information processing device 110 is a computer which performs various types of processing (threshold setting processing, monitoring processing and the like described later) based on the information sent from each of the production site system 103, the production planning device 104 and the production management device 105. The information processing device 110 is, for example, a server device, and comprises, as its constituent elements, a processor 111, a main storage device 112, an auxiliary storage device 113, and a communication device 114.

The processor 111 is a device that performs arithmetic processing. The processor 111 is, for example, a CPU (Central Processing Unit), an MPU (Micro Processing Unit), a GPU (Graphics Processing Unit), an AI (Artificial Intelligence) chip or the like.

The main storage device 112 is a device that stores programs, data and the like. The main storage device 112 is, for example, a ROM (Read Only Memory), a RAM (Random Access Memory) or the like. The ROM is an SRAM (Static Random Access Memory), an NVRAM (Non Volatile RAM), a mask ROM (Mask Read Only Memory), a PROM (Programmable ROM) or the like. The RAM is a DRAM (Dynamic Random Access Memory) or the like.

The auxiliary storage device 113 is a hard disk drive, a flash memory, an SSD (Solid State Drive), an optical storage device or the like. The optical storage device is a CD (Compact Disc), a DVD (Digital Versatile Disc) or the like. The programs and data stored in the auxiliary storage device 113 are read into the main storage device 112 as needed.

The communication device 114 is a communication interface which communicates with other device with a communication medium. The communication device 114 is, for example, an NIC (Network Interface Card), a wireless communication module, a USB (Universal Serial Interface) module, a serial communication module or the like. The communication device 114 can also function as an input device which receives information from other devices that are communicably connected. Moreover, the communication device 114 can also function as an output device which sends information to other devices that are communicably connected.

The information processing device 110 is not limited to the configuration described above. The information processing device 110 may comprise at least one of an input device and an output device. The input device is a user interface which receives information from a user. The input device is, for example, a keyboard, a mouse, a card reader, a touch panel or the like. The output device is a user interface which outputs (display output, sound output, print output or the like) various types of information. The output device is, for example, a display device which visualizes various types of information, a sound output device (speaker), a printing device or the like. The display device is an LCD (Liquid Crystal Display), a graphic card or the like.

The information storage device 120 is a computer which writes information in the auxiliary storage device 123 and reads information from the auxiliary storage device 123 based on a request from the information processing device 110. The information storage device 120 is a server device, a storage apparatus or the like, and comprises, as its constituent elements, a processor 121, a main storage device 122, an auxiliary storage device 123, and a communication device 124. Since the constituent elements of the information storage device 120 may be the same as the constituent elements of the information processing device 110, the explanation thereof is omitted.

The production site system 103 is provided for each factory. The production site system 103 comprises a production facility 131, a controller 132, a sensor 133, a site terminal 134, and a user terminal 135.

The production facility 131 is a facility for producing products. The number of production facilities 131 may be one production facility 131 or a plurality of production facilities 131. The controller 132 is a control device for controlling the production facility 131. One or more controllers 132 are provided in the production facility 131. The controller 132 sends actual production information, 4M information and other information to the information processing device 110.

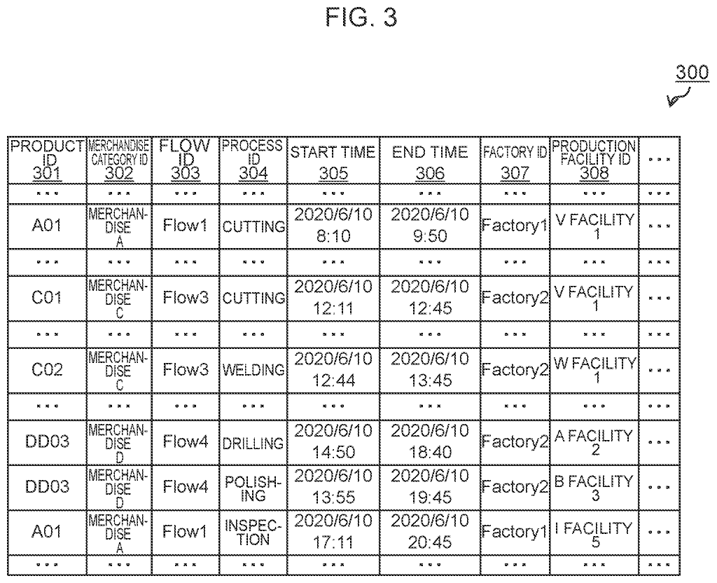

The actual production information is information including the actual production values related to the production of products in the production facility 131. For example, the controller 132 includes, in the actual production information, information indicating the time that the production of products was started in the production facility 131 or information indicating the time that the controller 132 operated the production facility 131, which was acquired by the sensor 133. Moreover, the controller 132 includes, as the actual production information, information indicating the time that the production of products was ended in the production facility 131 or information indicating the time that the controller 132 stopped the production facility 131, which was acquired by the sensor 133. The actual production information will be explained later with reference to FIG. 3.

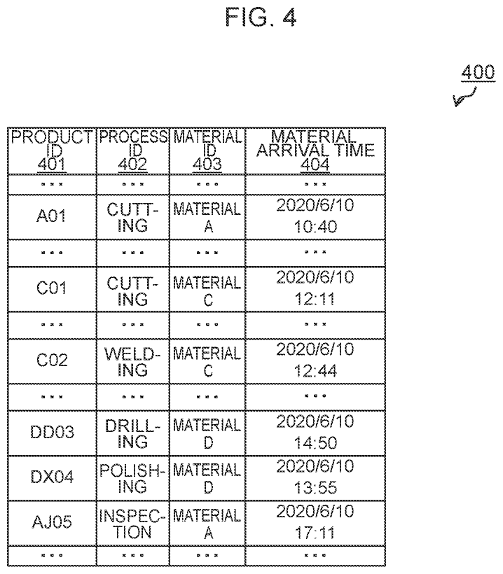

The 4M information is at least once piece of information among machine status information, material status information, worker status information, and process status information. For example, the controller 132 includes, in the 4M information, information indicating the time that the material arrived at the production facility 131 or information indicating the time that the material that can be acquired from the production facility 131 was set, which was acquired by the sensor 133. Note that the 4M information will be explained later with reference to FIG. 4.

The sensor 133 is a sensor for measuring the status (condition) of the production facility 131. The sensor 133 sends information (sensor values) indicating the status of the production facility 131 to the information processing device 110. The sensor 133 may be a sensor that detects the start of production of products in the production facility 131, a sensor that detects the end of production of products in the production facility 131, a sensor that detects the arrival of the materials at the production facility 131, or any other sensor. Note that the sensor 133 does not need to be provided in the production site system 103. Moreover, the configuration may also be such that the sensor value is sent to the information processing device 110 via the controller 132.

The site terminal 134 is a terminal to be used by a worker for confirming information related to the production of products in the production facility 131. For example, the site terminal 134 outputs an alert screen described later which is sent by the information processing device 110. Note that the site terminal 134 is a laptop computer, a tablet terminal or the like, and configured by including a processor, a main storage device, an auxiliary storage device, a communication device, an input device, an output device and the like.

The user terminal 135 is a terminal to be used by a worker for inputting a part or all of the actual production information. Note that the user terminal 135 is a laptop computer, a tablet terminal or the like, and configured by including a processor, a main storage device, an auxiliary storage device, a communication device, an input device, an output device and the like. In addition, the production management system 100 does not need to comprise the user terminal 135.

The production planning device 104 is a device which creates production plan information indicating a plan (production plan) which specifies the products to be produced in the production facility 131. The production planning device 104 creates, for example, at a predetermined timing or based on a request of a production plan from the information processing device 110, the production plan information based on a list of the production facilities 131 that can be used for performing each process related to the products, information indicating the injection time and the completion time of the product (material), and a list of workers available for performing work, and sends the created production plan information to the information processing device 110. The predetermined timing may be a predetermined cycle, a predetermined time, timing instructed by a worker, or any other timing.

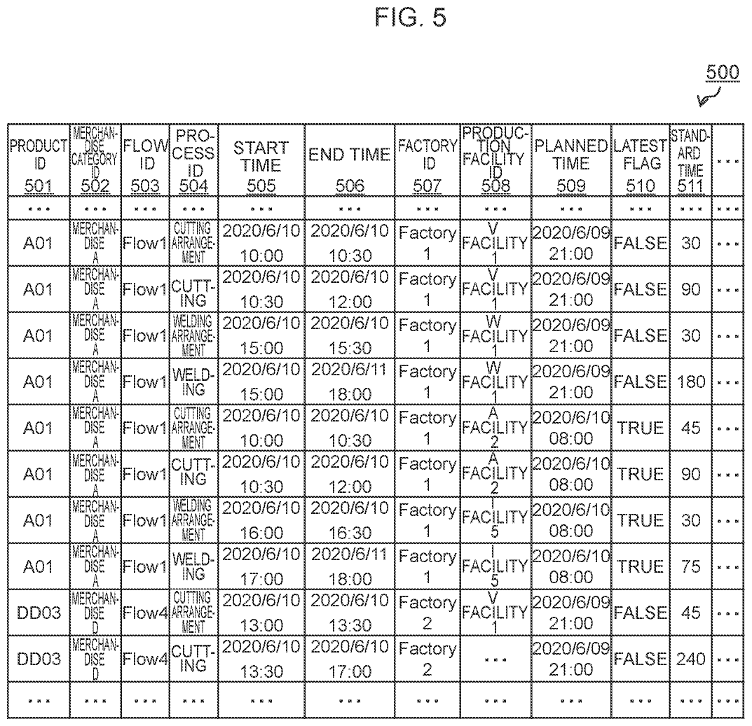

The production plan information includes information indicating which production facility 131 will be used for how long to produce the products; that is, information indicating the process that the products will undergo. Note that the production plan information will be explained later with reference to FIG. 5. Moreover, the production planning device 104 is, for example, a server device, and configured by including a processor, a main storage device, an auxiliary storage device, a communication device, an input device, an output device and the like. In addition, the production planning device 104 may also be a publicly known scheduler.

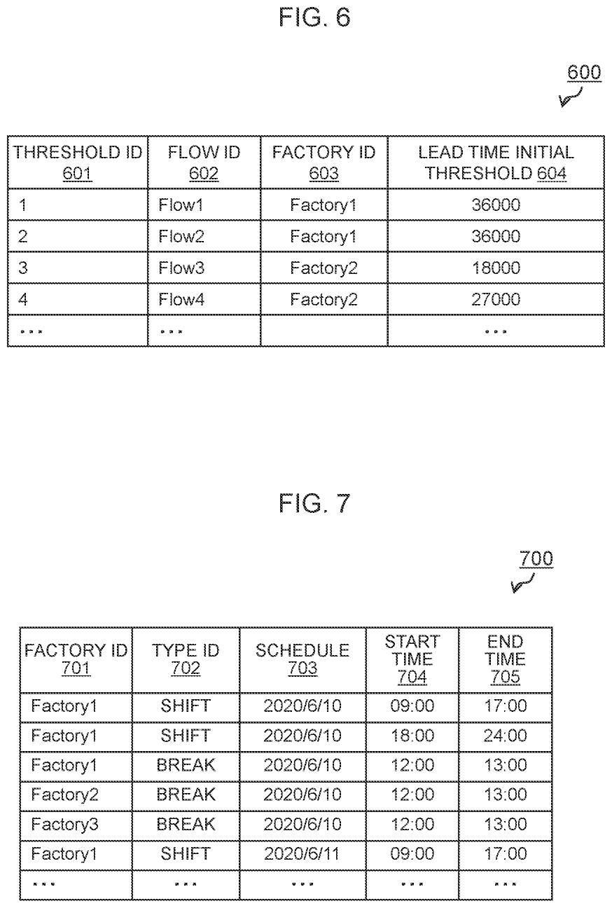

The production management device 105 is a device for managing the information related to the production of products in the production facility 131. The production management device 105 manages, for example, master information, external factor information and other information, and sends the master information and the external factor information to the information processing device 110. The master information includes information indicating an initial threshold for detecting an abnormality in the production of products in the production facility 131. The external factor information includes information indicating the time that the production facility 131 was or was not in operation. Note that the master information will be explained later with reference to FIG. 6. The external factor information will be explained later with reference to FIG. 7. Moreover, the production management device 105 is, for example, a server device, and configured by including a processor, a main storage device, an auxiliary storage device, a communication device, an input device, an output device and the like.

Note that the production management system 100 is not limited to the configuration described above. For example, the actual production visualization system 101 may comprise at least one of the production planning device 104 and the production management device 105. Moreover, for example, the site terminal 134 and the user terminal 135 may be the same terminal. Moreover, for example, the information processing device 110 and the information storage device 120 may be the same device.

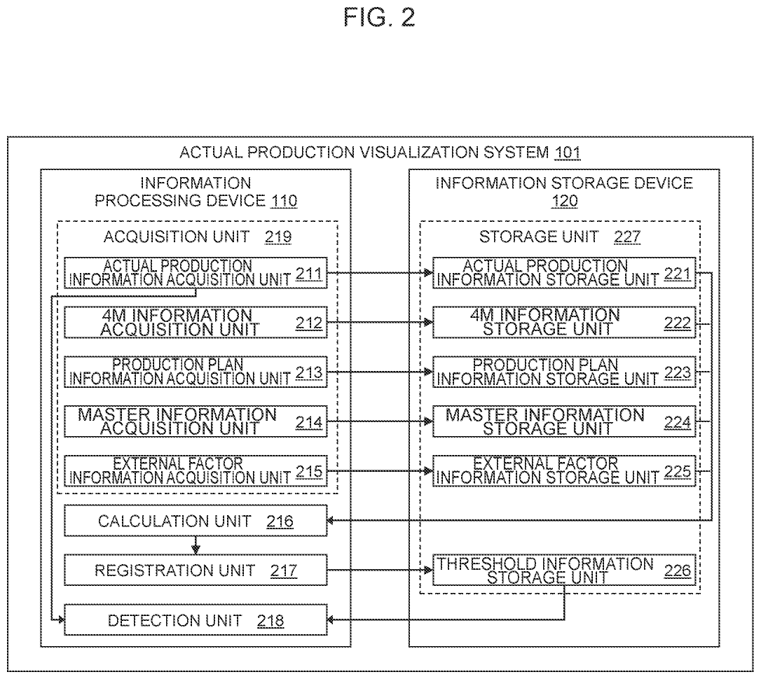

FIG. 2 is a diagram showing an example of the configuration of the actual production visualization system 101. The actual production visualization system 101 comprises an information processing device 110 and an information storage device 120.

The information processing device 110 comprises an actual production information acquisition unit 211, a 4M information acquisition unit 212, a production plan information acquisition unit 213, a master information acquisition unit 214, an external factor information acquisition unit 215, a calculation unit 216, a registration unit 217, and a detection unit 218. In the following explanation, when the actual production information acquisition unit 211, the 4M information acquisition unit 212, the production plan information acquisition unit 213, the master information acquisition unit 214, and the external factor information acquisition unit 215 do not need to be differentiated, they may be collectively referred to as the “acquisition unit 219”.

The actual production information acquisition unit 211 acquires (for example, receives) the actual production information from each of the controller 132, the sensor 133 and the user terminal 135 at a suitable timing, and sends the acquired actual production information to the information storage device 120. The 4M information acquisition unit 212 acquires the 4M information from the controller 132 at a suitable timing, and sends the acquired 4M information to the information storage device 120. The production plan information acquisition unit 213 acquires the production plan information from the production planning device 104 at a suitable timing, and sends the acquired production plan information to the information storage device 120. The master information acquisition unit 214 acquires the master information from the production management device 105 at a suitable timing, and sends the acquired master information to the information storage device 120. The external factor information acquisition unit 215 acquires the external factor information from the production management device 105 at a suitable timing, and sends the acquired external factor information to the information storage device 120.

The calculation unit 216 acquires the actual production information, the 4M information, the production plan information, the master information, and the external factor information from the information storage device 120, and calculates a threshold according to the status of the production facility 131 based on the acquired information. The registration unit 217 presents to an administrator (for example, displays on a screen) the threshold calculated by the calculation unit 216, and sends, to the information storage device 120, the threshold information indicating the threshold adopted by the administrator. Note that the registration unit 217 may also send, to the information storage device 120, the threshold information indicating the threshold calculated by the calculation unit 216 without presenting the threshold information to the administrator. The detection unit 218 acquires the threshold information according to the status of the production facility 131 from the information storage device 120, detects an abnormality in the production of products in the production facility 131 by using the acquired threshold information and the actual production information acquired by the actual production information acquisition unit 211, and sends the detected abnormality, as an alert screen, to the user terminal 135.

The functions (calculation unit 216, registration unit 217, detection unit 218, acquisition unit 219 and the like) of the information processing device 110 may be realized, for example, by the processor 111 reading the programs stored in the auxiliary storage device 113 into the main storage device 112 and executing the programs (software), or realized with hardware such as a dedicated circuit or the like, or realized based on a combination of software and hardware. Note that one function of the information processing device 110 may be divided into a plurality of functions, or a plurality of functions may be consolidated into one function. Moreover, a part of the functions of the information processing device 110 may be provided as a separate function, or included in another function. Moreover, a part of the functions of the information processing device 110 may be realized with another machine (physical machine or virtual machine) capable of communicating with the information processing device 110.

The information storage device 120 comprises an actual production information storage unit 221, a 4M information storage unit 222, a production plan information storage unit 223, a master information storage unit 224, an external factor information storage unit 225, and a threshold information storage unit 226. In the following explanation, when the actual production information storage unit 221, the 4M information storage unit 222, the production plan information storage unit 223, the master information storage unit 224, the external factor information storage unit 225, and the threshold information storage unit 226 do not need to be differentiated, they may be collectively referred to as the “storage unit 227”.

The actual production information storage unit 221 stores the actual production information sent from the actual production information acquisition unit 211 in the auxiliary storage device 123. The actual production information storage unit 221 reads the actual production information requested by the calculation unit 216 from the auxiliary storage device 123, and sends the read actual production information to the calculation unit 216. The 4M information storage unit 222 stores the 4M information sent from the 4M information acquisition unit 212 in the auxiliary storage device 123. The 4M information storage unit 222 reads the 4M information requested by the calculation unit 216 from the auxiliary storage device 123, and sends the read 4M information to the calculation unit 216.

The production plan information storage unit 223 stores the production plan information sent from the production plan information acquisition unit 213 in the auxiliary storage device 123. The production plan information storage unit 223 reads the production plan information requested by the calculation unit 216 from the auxiliary storage device 123, and sends the read production plan information to the calculation unit 216. The master information storage unit 224 stores the master information sent from the master information acquisition unit 214 in the auxiliary storage device 123. The master information storage unit 224 reads the master information requested by the calculation unit 216 from the auxiliary storage device 123, and sends the read master information to the calculation unit 216.

The external factor information storage unit 225 stores the external factor information sent from the external factor information acquisition unit 215 in the auxiliary storage device 123. The external factor information storage unit 225 reads the external factor information requested by the calculation unit 216 from the auxiliary storage device 123, and sends the read external factor information to the calculation unit 216. The threshold information storage unit 226 stores the threshold information sent from the registration unit 217 in the auxiliary storage device 123. The threshold information storage unit 226 reads the threshold information requested by the detection unit 218 from the auxiliary storage device 123, and sends the read threshold information to the detection unit 218.

The functions (storage unit 227 and the like) of the information storage device 120 may be realized, for example, by the processor 121 reading the programs stored in the auxiliary storage device 123 into the main storage device 122 and executing the programs (software), or realized with hardware such as a dedicated circuit or the like, or realized based on a combination of software and hardware. Note that one function of the information storage device 120 may be divided into a plurality of functions, or a plurality of functions may be consolidated into one function. Moreover, a part of the functions of the information storage device 120 may be provided as a separate function, or included in another function. Moreover, a part of the functions of the information storage device 120 may be realized with another computer capable of communicating with the information storage device 120.

In addition, the storage unit 227 stores information for a predetermined period (1 year, 5 years, 10 years or the like). Note that the predetermined period may be prescribed for each storage unit 227.

FIG. 3 is a diagram showing an example (actual production table 300) of the actual production information.

The actual production table 300 stores a record including values of a plurality of items indicating the actual production information. More specifically, the actual production table 300 stores a record in which information such as a product ID 301, a merchandise category ID 302, a flow ID 303, a process ID 304, a start time 305, an end time 306, a factory ID 307, and a production facility ID 308 are associated.

The product ID 301 is an item indicating the identification information capable of identifying the product produced in the production facility 131. The merchandise category ID 302 is an item indicating the merchandise category (type) of the product. The flow ID 303 is an item indicating the identification information capable of identifying the flow showing the order of processes in producing the product. Note that the flow is configured by including one or more processes. The process ID 304 is an item indicating the identification information capable of identifying the process of the work (cutting, welding, drilling, polishing, inspection or the like) performed to the product among the respective processes in the flow. The start time 305 is an item indicating the time that the process was started. The end time 306 is an item indicating the time that the process was ended. The factory ID 307 is an item indicating the identification information capable of identifying the factory equipped with the production facility 131 that produced the product. The production facility ID 308 is an item indicating the identification information capable of identifying the production facility 131 that handled the process. Note that one production facility 131 may handle one type or multiple types of processes.

FIG. 4 is a diagram showing an example (4M table 400) of the 4M information.

The 4M table 400 is provided for each factory. The 4M table 400 stores a record including values of a plurality of items indicating the material status information (information related to the materials used in each process of the flow of the product) out of the 4M information. More specifically, the 4M table 400 stores a record in which information such as a product ID 401, a process ID 402, a material ID 403, and a material arrival time 404 are associated.

The product ID 401 is an item indicating the identification information capable of identifying the product produced in the production facility 131. The process ID 402 is an item indicating the identification information capable of identifying the process in the flow of the product. The material ID 403 is an item indicating the identification information capable of identifying the material (component, paint or the like) used in the process. The material arrival time 404 is an item indicating the time that the material arrived at the production facility 131 that was in charge of the process.

FIG. 5 is a diagram showing an example (production plan table 500) of the production plan information.

The production plan table 500 stores a record including values of a plurality of items indicating the production plan information. More specifically, the production plan table 500 stores a record in which information such as a product ID 501, a merchandise category ID 502, a flow ID 503, a process ID 504, a start time 505, an end time 506, a factory ID 507, a production facility ID 508, a planned time 509, a latest flag 510, and a standard time 511 are associated.

The product ID 501 is an item indicating the identification information capable of identifying the product to be produced in the production facility 131. The merchandise category ID 502 is an item indicating the merchandise category of the product. The flow ID 503 is an item indicating the identification information capable of identifying the flow of the product. The process ID 504 is an item indicating the identification information capable of identifying the process of the work performed to the product among the respective processes in the flow. The start time 505 is an item indicating the time that the process was started. The end time 506 is an item indicating the time that the process was ended. The factory ID 507 is an item indicating the identification information capable of identifying the factory equipped with the production facility 131 that produced the product.

The production facility ID 508 is an item indicating the identification information capable of identifying the production facility 131 that handled the process. The planned time 509 is an item indicating the time that the record (production plan) was created. The latest flag 510 is an item indicating whether the production plan is an initial production plan (initial plan) or a new production plan (new plan). “FALSE” is set in the latest flag 510 when the production plan is an initial plan, and “TRUE” is set in the latest flag 510 when the production plan is a new plan. The standard time 511 is an item indicating the standard time required for the process.

FIG. 6 is a diagram showing an example (master table 600) of the master information.

The master table 600 stores a record including values of a plurality of items indicating the master information. More specifically, the master table 600 stores a record in which information such as a threshold ID 601, a flow ID 602, a factory ID 603, and a lead time initial threshold 604 are associated.

The threshold ID 601 is an item indicating the identification information capable of identifying the record (initial threshold of the lead time stored in the master table 600). The flow ID 602 is an item indicating the identification information capable of identifying the flow for which the initial threshold is set. The factory ID 603 is an item indicating the identification information capable of identifying the factory to use the initial threshold. The lead time initial threshold 604 is an item indicating the initial threshold.

Note that, while a case of providing the initial threshold (lead time initial threshold 604) for each factory and for each flow was explained, the configuration is not limited thereto. The initial threshold may be provided for each factory, or provided for each merchandise category of the product. Moreover, the master information is not limited to the master table 600 described above. For example, the master information may also include the target value calculated in the operational availability threshold calculation processing described later, or the target value registered by a worker or the like.

FIG. 7 is a diagram showing an example (external factor table 700) of the external factor information.

The external factor table 700 stores a record including values of a plurality of items indicating the external factor information. More specifically, the external factor table 700 stores a record in which information such as a factory ID 701, a type ID 702, a schedule 703, a start time 704, and an end time 705 are associated.

The factory ID 701 is an item indicating the identification information capable of identifying the factory. The type ID 702 is an item indicating the identification information capable of identifying the type of factor in which the production facility 131 will be stopped in the factory (shift indicating the worker's working style, worker's break or the like). The schedule 703 is an item indicating the day (schedule) that the factor occurred. The start time 704 is an item indicating the start time of the factor. The end time 705 is an item indicating the end time of the factor.

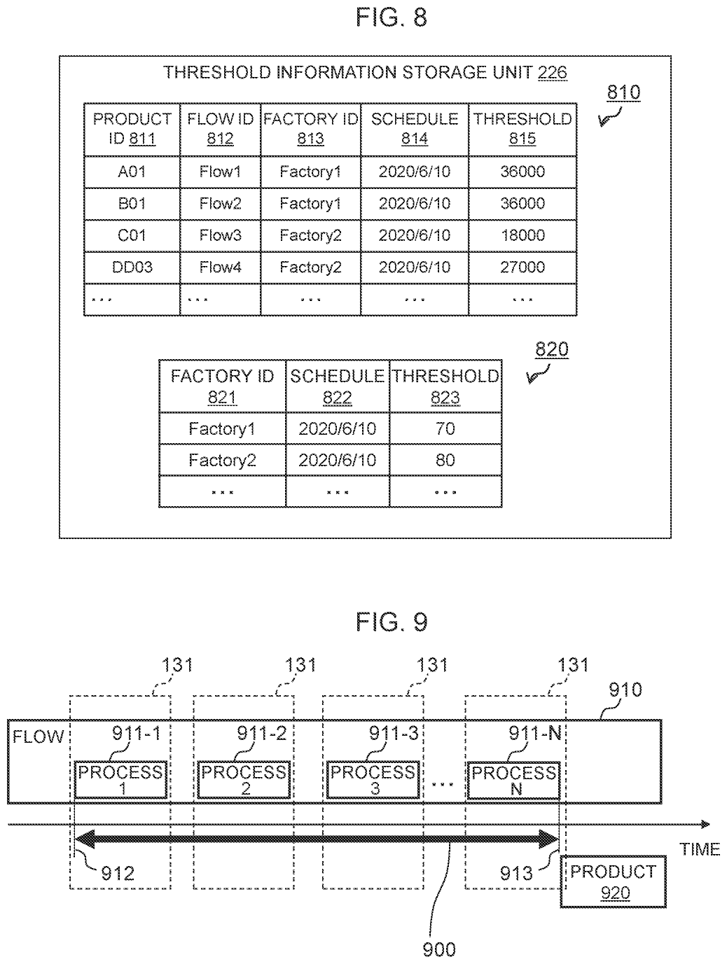

FIG. 8 is a diagram showing an example (lead time threshold table 810 and operational availability threshold table 820) of the threshold information stored in the threshold information storage unit 226.

The lead time threshold table 810 stores a record including values of a plurality of items indicating the threshold information of the lead time. More specifically, the lead time threshold table 810 stores a record in which information such as a product ID 811, a flow ID 812, a factory ID 813, a schedule 814, and a threshold 815 are associated.

The product ID 811 is an item indicating the identification information capable of identifying the product to be produced in the production facility 131. The flow ID 812 is an item indicating the identification information capable of identifying the flow of the product. The factory ID 813 is an item indicating the identification information capable of identifying the factory equipped with the production facility 131 that produced the product. The schedule 814 is an item indicating the day (schedule) that the product is to be produced. The threshold 815 is an item indicating the threshold of the lead time of the product. Note that the lead time will be explained later with reference to FIG. 9.

The operational availability threshold table 820 stores a record including values of a plurality of items indicating the threshold information of the operational availability. More specifically, the operational availability threshold table 820 stores a record in which information such as a factory ID 821, a schedule 822, and a threshold 823 are associated.

The factory ID 821 is an item indicating the identification information capable of identifying the factory. The schedule 822 is an item indicating the day (schedule) that the product is to be produced in the production facility 131 of the factory. The threshold 823 is an item indicating the threshold of the operational availability of the factory. The operational availability is calculated, for example, based on following (Formula 1).

operational availability=operating time/available time (Formula 1)

The operating time is the time that the production facility 131 conducted its production activity. The available time is the time from the start to end (operating time) of the production facility 131. Here, the production facility 131 is stopped due to various factors such as the time between shifts, break, machine maintenance, malfunction or the like. In other words, the term “operating time” is the time obtained by subtracting the downtime from the available time.

FIG. 9 is a diagram showing an example (lead time 900) of the lead time.

The lead time 900 is the time from the start of the production of a product 920 to the end of the production of the product 920 according to a predetermined flow 910. Here, the flow 910 consists of a plurality of processes 911, and a first process 911-1 is a first process (start process), and an Nth process 911-N is a final process (end process). Thus, the lead time 900 of the product 920 is the time from the start time 912 of the first process 911-1 to the end time 913 of the Nth process 911-N.

Note that, while this embodiment explains a case in which one process is handled by one production facility 131, the configuration is not limited thereto. For example, one process may also be handled by a plurality of production facilities 131.

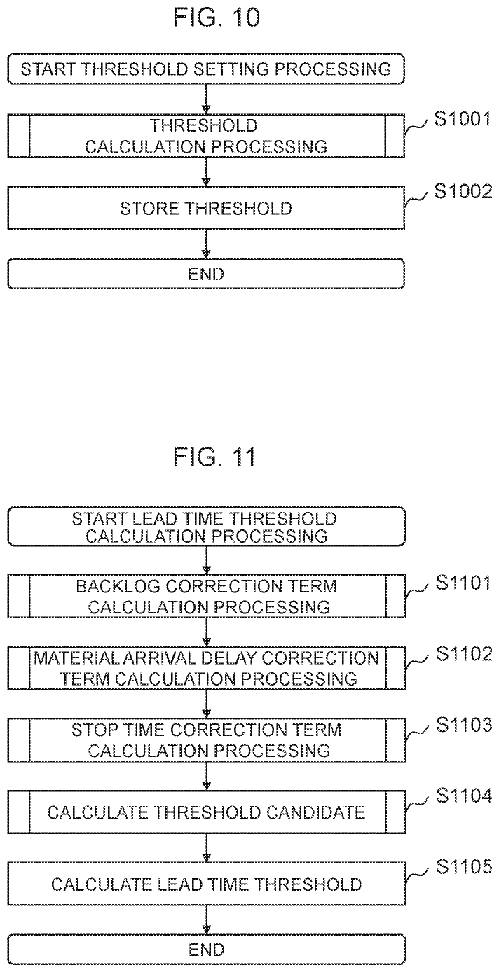

FIG. 10 is a diagram showing an example of the threshold setting processing. The threshold setting processing is executed at a suitable timing. The suitable timing may be a predetermined cycle, a predetermined time, timing instructed by a worker, or any other timing.

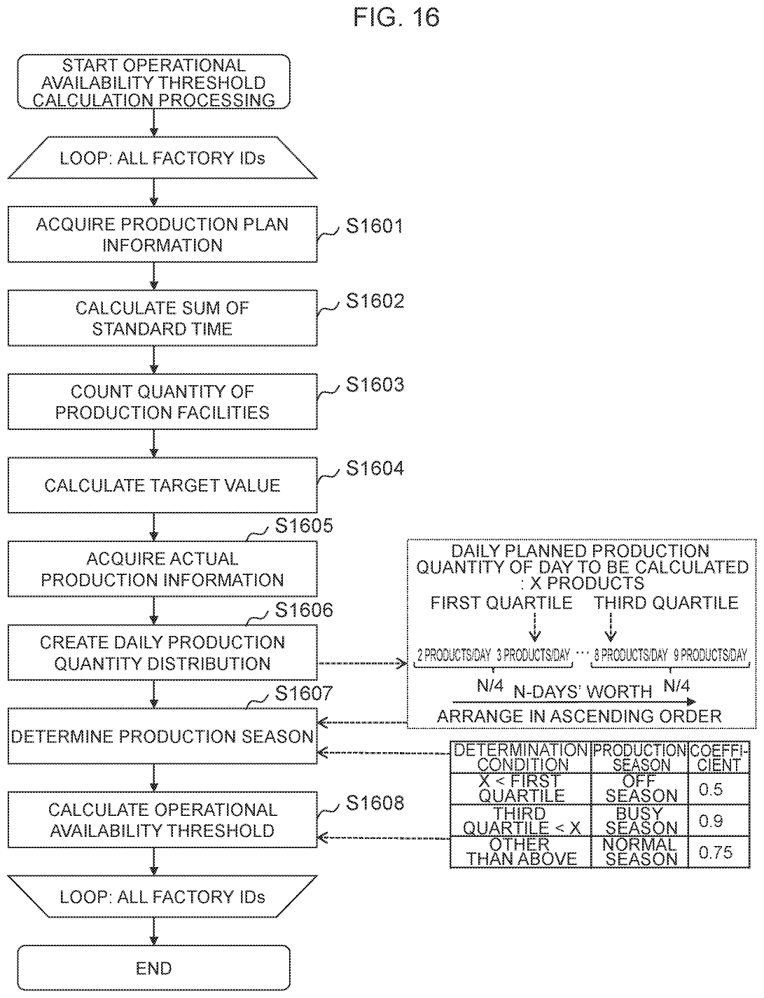

In step S1001, the information processing device 110 executes the threshold calculation processing. In the threshold calculation processing, a predetermined threshold according to the status of the current production facility 131 is calculated. A predetermined threshold is a lead time threshold, an operational availability threshold, a standby time threshold or the like. In the following explanation, the lead time threshold calculation processing of calculating the lead time threshold will be explained later with reference to FIG. 11 to FIG. 15, and the operational availability threshold calculation processing of calculating the operational availability threshold will be explained later with reference to FIG. 16.

In step S1002, the information processing device 110 sends the threshold calculated in step S1001 to the information storage device 120. The information storage device 120 stores the received threshold in the lead time threshold table 810 or the operational availability threshold table 820.

Note that the information processing device 110 may also present the threshold calculated in step S1001 to the administrator, and send the threshold adopted by the administrator to the information storage device 120.

FIG. 11 is a diagram showing an example of the lead time threshold calculation processing.

In the lead time threshold calculation processing, the information processing device 110 calculates the lead time threshold based on following (Formula 2), and following (Formula 2-1) or (Formula 2-2).

threshold candidate=initial threshold+correction term (Formula 2)

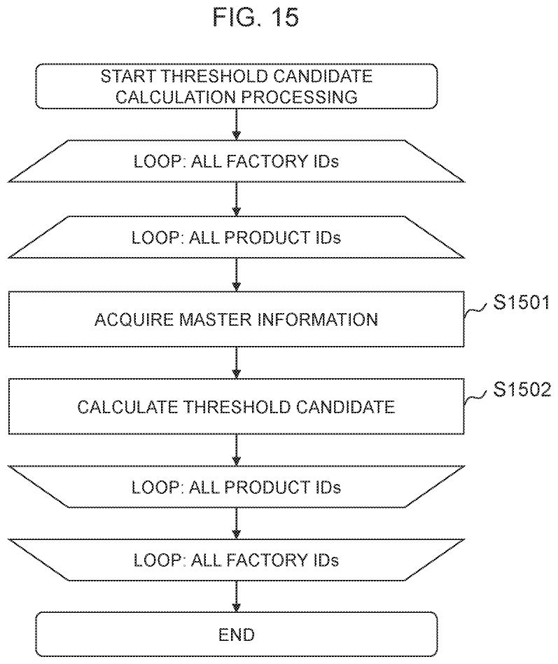

In (Formula 2), a value of the lead time initial threshold 604 included in the master table 600 is set in the initial threshold. The correction term is calculated and set based on at least one processing among step S1101, step S1102 and step S1103 described later. Note that, in the following explanation, the calculation method of the threshold candidate will be explained later with reference to step S1104 (FIG. 15) on the assumption that all processing of step S1101, step S1102, and step S1103 will be performed.

When the information processing device 110 calculates the threshold candidate, the information processing device 110 calculates the lead time threshold based on following (Formula 2-1) or (Formula 2-2) (by using the threshold candidate and the actual production lead time).

<When threshold candidate≥MIN(actual production lead time)>lead time threshold=threshold candidate (Formula 2-1)

<When threshold candidate<MIN(actual production lead time)>lead time threshold=MIN(actual production lead time) (Formula 2-2)

Note that the calculation method of the lead time threshold (actual production lead time and the like) will be explained later with reference to step S1105.

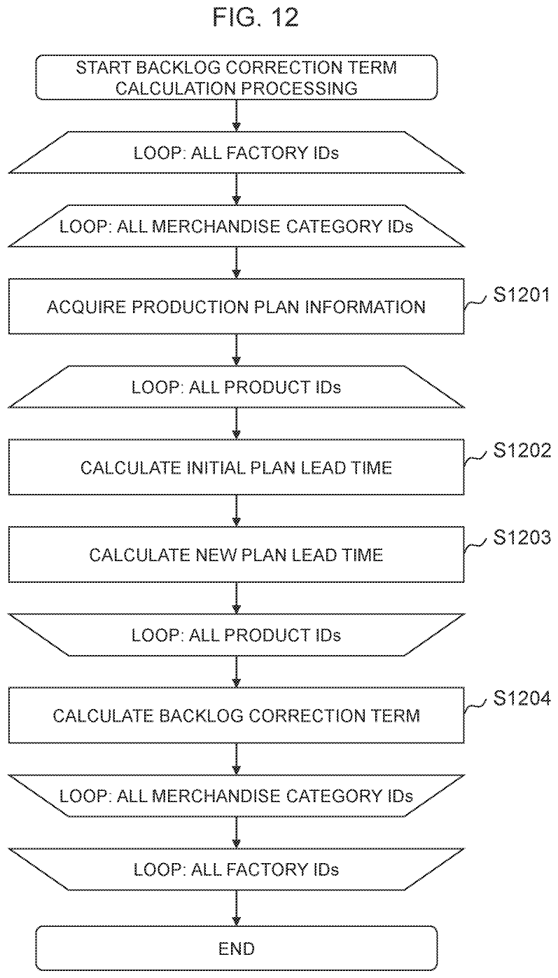

In step S1101, the information processing device 110 performs the backlog correction term calculation processing. In the backlog correction term calculation processing, a backlog correction term is calculated. Note that the backlog correction term calculation processing will be explained later with reference to FIG. 12.

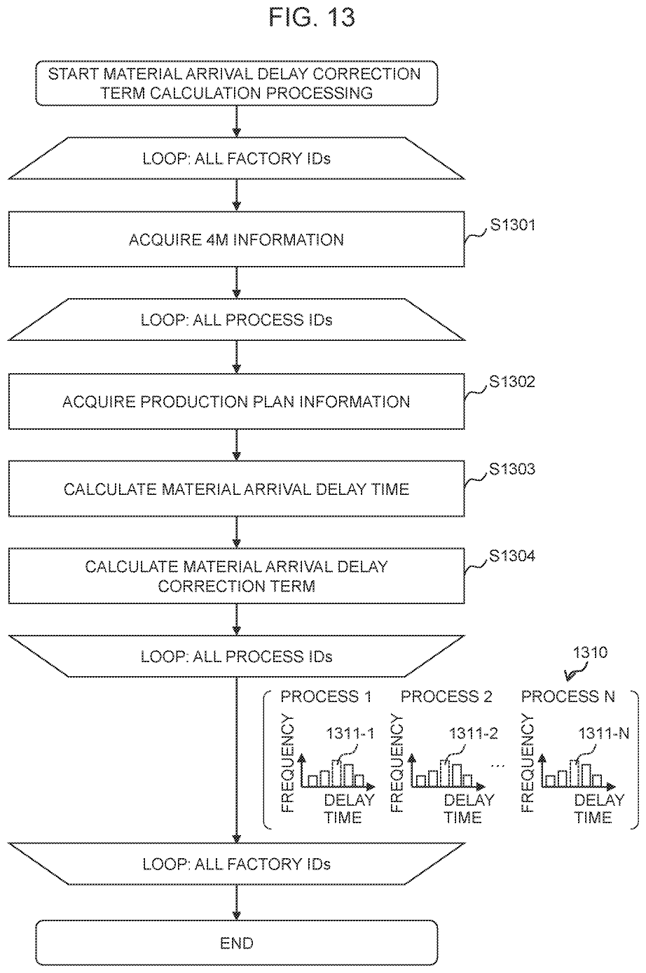

In step S1102, the information processing device 110 performs the material arrival delay correction term calculation processing. In the material arrival delay correction term calculation processing, a material arrival delay correction term is calculated. Note that the material arrival delay correction term calculation processing will be explained later with reference to FIG. 13.

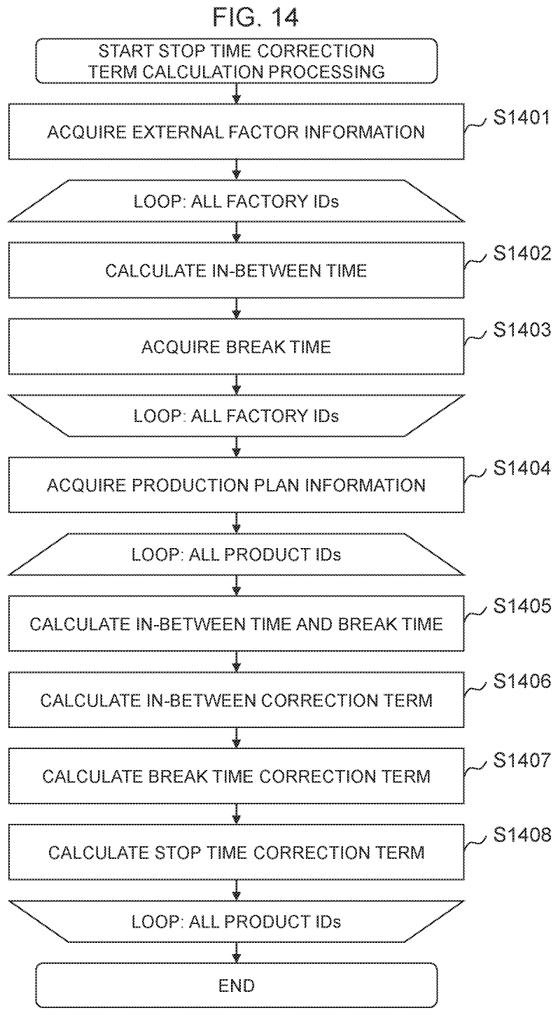

In step S1103, the information processing device 110 performs the downtime correction term calculation processing. In the downtime correction term calculation processing, a downtime correction term is calculated. Note that the downtime correction term calculation processing will be explained later with reference to FIG. 14.

In step S1104, the information processing device 110 performs the threshold candidate calculation processing. In the threshold candidate calculation processing, a threshold candidate is calculated for each product based on the backlog correction term, the material arrival delay correction term, and the downtime correction term. Note that the threshold candidate calculation processing will be explained later with reference to FIG. 15.

In step S1105, the information processing device 110 calculates a lead time threshold. For example, the information processing device 110 refers to the actual production table 300 and the production plan table 500, calculates, for each product included in a record (new plan) in which the planned time 509 is the calculation target date and the latest flag 510 is “TRUE”, the actual production lead time for each same merchandise category product (time difference between the earliest start time 505 of all processes of the same merchandise category product and the latest end time 506 of all processes of the same merchandise category product) from the record of the product of the merchandise category ID with which the merchandise category ID 302 of that product coincides (same merchandise category product), and identifies the smallest actual production lead time (minimum value of the actual production lead time) among the calculated actual production lead times.

Subsequently, the information processing device 110 compares, for each product included in the new plan, the threshold candidate of the product and the minimum value of the actual production lead time of the same merchandise category as that product. When the threshold candidate is equal to or greater than the minimum value of the actual production lead time, the information processing device 110 uses that threshold candidate as the lead time threshold as shown in (Formula 2-1), and when the threshold candidate is less than the minimum value of the actual production lead time, the information processing device 110 uses the minimum value of the actual production lead time as the lead time threshold as shown in (Formula 2-2). Note that the calculation target date is the day that the threshold is used in the monitoring processing described later, and may also be a day that is designated by the worker. Nevertheless, when calculating the backlog correction term, the threshold setting processing needs to be executed after the production plan information of the new plan is acquired.

According to the processing described above, it is possible to avoid an unfeasible threshold from being set. In addition, when the information processing device 110 does not calculate the backlog correction term, the information processing device 110 refers to the record (initial plan) in which the latest flag 510 is “FALSE”, and not the record (new plan) in which the latest flag 510 is “TRUE”, in identifying the minimum value of the actual production lead time.

FIG. 12 is a diagram showing an example of the backlog correction term calculation processing.

In the backlog correction term calculation processing, the information processing device 110 performs the processing of step S1201 and step S1204 for each factory ID and for each merchandise category ID. Moreover, the information processing device 110 performs the processing of step S1202 and step S1203 for each factory ID, for each merchandise category ID, and for each product ID.

In step S1201, the information processing device 110 acquires the production plan information. For example, the information processing device 110 acquires, from the production plan table 500, all records in which the factory ID 507 coincides with the factory ID to be processed and in which the merchandise category ID 502 coincides with the merchandise category ID to be processed, and in which the calculation target date is (calculation target date 00:00:00<=start time 505, and end time 506<=calculation target date 23:59:59).

Here, the production planning device 104 creates, by the timing (suitable timing) that the threshold setting processing is executed, the production plan information of the initial plan of the calculation target date (for example, record in which the latest flag 510 is “FALSE”), and the production plan information of the new plan in which the backlog has been added to the initial plan (for example, record in which the latest flag 510 is “TRUE”), and sends the created production plan information to the information processing device 110. The information processing device 110 sends the received production plan information of the initial plan and the received production plan information of the new plan to the information storage device 120. The information storage device 120 stores the received production plan information of the initial plan and the received production plan information of the new plan in the production plan table 500.

In step S1202, the information processing device 110 calculates the initial plan lead time. For example, the information processing device 110 calculates, for each product of the product ID to be processed as the merchandise category of the merchandise category ID to be processed in the factory of the factory ID to be processed, the time difference between the earliest start time 505 of all processes of the product and the latest end time 506 of all processes of that product as the initial plan lead time from the record in which the latest flag 510 is “FALSE”.

For example, when the factory ID to be processed is “Factory 1” and the merchandise category ID to be processed is “merchandise A”, the information processing device 110 refers to the record of the second line to the record of the fifth line, as the records in which the latest flag 510 is “FALSE” for products having the product ID 501 of “A01”, and calculates the time difference of “8 hours” between the start time of “10:00” of the record of the second line in which the start time 505 is the earliest and the start time of “18:00” of the fifth line in which the end time 506 is the latest as the initial plan lead time.

In step S1203, the information processing device 110 calculates the new plan lead time. For example, the information processing device 110 calculates, for each product of the product ID to be processed as the merchandise category of the merchandise category ID to be processed in the factory of the factory ID to be processed, the time difference between the earliest start time 505 of all processes of the product and the latest end time 506 of all processes of that product as the new plan lead time from the record in which the latest flag 510 is “TRUE”.

For example, when the factory ID to be processed is “Factory 1” and the merchandise category ID to be processed is “merchandise A”, the information processing device 110 refers to the record of the sixth line to the record of the ninth line, as the records in which the latest flag 510 is “TRUE” for products having the product ID 501 of “A01”, and calculates the time difference of “8 hours” between the start time of “10:00” of the record of the sixth line in which the start time 505 is the earliest and the start time of “18:00” of the ninth line in which the end time 506 is the latest as the new plan lead time.

In step S1204, the information processing device 110 calculates the backlog correction term. For example, the information processing device 110 calculates the average of the initial plan lead time and the average of the new plan lead time, respectively, for each factory ID and for each merchandise category ID, and calculates the difference between the average of the initial plan lead time and the average of the new plan lead time as the backlog correction term. Note that the information processing device 110 associates the calculated backlog correction term with the factory ID to be processed and the merchandise category ID to be processed, and stores it in the auxiliary storage device 113.

As described above, according to the backlog correction term calculation processing, the backlog correction term is calculated for each factory and for each product merchandise category. Note that the information processing device 110 may also calculate the backlog correction term for each factory and for each product, or calculate the backlog correction term for each factory.

FIG. 13 is a diagram showing an example of the material arrival delay correction term calculation processing.

In the material arrival delay correction term calculation processing, the information processing device 110 performs the processing of step S1301 for each factory ID. Moreover, the information processing device 110 performs the processing of step S1302 to step S1304 for each factory ID and for each process ID.

In step S1301, the information processing device 110 acquires the 4M information. For example, the information processing device 110 acquires all records (each of these records is hereinafter sometimes referred to as the “material arrival record”) from the 4M table 400 corresponding to the factory having the factory ID to be processed.

In step S1302, the information processing device 110 acquires the production plan information. For example, the information processing device 110 acquires, from the production plan table 500, all records (each of these records is hereinafter sometimes referred to as the “production plan record”) in which the factory ID 507 coincides with the factory ID to be processed, the process ID 504 coincides with the process ID to be processed, and the latest flag 510 is “TRUE” (“FALSE” in cases where a new plan is not created). Note that, since a product of a record in which the planned time 509 is the calculation target date has not yet been produced (since there is no material arrival record corresponding to the record in which the planned time 509 is the calculation target date), the information processing device 110 may also acquire a record in which the planned time 509 is a day preceding the calculation target date.

In step S1303, the information processing device 110 calculates the material arrival delay time. For example, the information processing device 110 calculates the time difference between the material arrival time 404 of the material arrival record and the start time 505 of the production plan record regarding the material arrival record and the production plan record in which the process ID and the product ID coincide. The information processing device 110 calculates, as the material arrival delay time, the time difference when the time difference is greater than “0”, and calculates “0” when the time difference is “0” or less. Note that, when a plurality of types of materials will arrive for one process, the information processing device 110 calculates, for example, the time difference for each material, and may use the average of the calculated time difference, or use any other statistical value.

In step S1304, the information processing device 110 calculates the arrival time delay correction term. For example, the information processing device 110 creates the distribution of the material arrival delay time for each process, identifies the mode value in the distribution, and uses the material arrival delay time of the mode value as the material arrival delay correction term. Note that the information processing device 110 associates the calculated material arrival delay correction term with the factory ID to be processed and the process ID to be processed, and stores it in the auxiliary storage device 113.

Here, when the processing of step S1302 to step S1304 is performed for the process ID to be processed, for example, the material arrival delay time of the mode value 1311 is used as the material arrival delay correction term for each process as shown in the processing result image 1310.

As described above, according to the material arrival delay correction term calculation processing, the material arrival delay correction term is calculated for each factory and for each process. Note that the information processing device 110 may also calculate the material arrival delay correction term for each factory and for each flow, or calculate the material arrival delay correction term for each factory.

FIG. 14 is a diagram showing an example of the downtime correction term calculation processing.

In the downtime correction term calculation processing, the information processing device 110 performs the processing of step S1402 and step S1403 for each factory ID.

Moreover, the information processing device 110 performs the processing of step S1405 to step S1408 for each product ID.

In step S1401, the information processing device 110 acquires the external factor information. For example, the information processing device 110 acquires, from the external factor table 700, a record in which the schedule 703 coincides with the calculation target date.

In step S1402, the information processing device 110 calculates the in-between time. For example, the information processing device 110 extracts, from the records acquired in step S1401, a record in which the factory ID 701 coincides with the factory ID to be processed and the type ID 702 is “shift”, and, when the extracted record is sorted based on the start time 704, the time between the end time 705 of one record (previous shift) and the start time 704 of the record (subsequent shift) subsequent to the one record is calculated as the in-between time. To put it differently, the information processing device 110 uses the end time 705 of the previous shift as the start time of the in-between time, and uses the start time 704 of the subsequent shift as the end time of the in-between time.

In step S1403, the information processing device 110 acquires the break time. For example, the information processing device 110 extracts, from the records acquired in step S1401, a record in which the factory ID 701 coincides with the factory ID to be processed and the type ID 702 is “break”, and for each of the extracted records, uses the start time 704 as the start time of the break time, and uses the end time 705 as the end time of the break time.

In step S1404, the information processing device 110 acquires the production plan information. For example, the information processing device 110 acquires, from the production plan table 500, all records (each of these records is hereinafter referred to as the “production plan record”) in which the latest flag 510 is “TRUE” (“FALSE” in cases where a new plan is not created), and the calculation target date is (calculation target date 00:00:00<=start time 505, and end time 506<=calculation target date 23:59:59).

In step S1405, the information processing device 110 calculates the in-between time and the break time. For example, the information processing device 110 extracts, from the in-between time and the break time acquired in step S1403 and step S1404, the in-between time (start time of the in-between time and end time of the in-between time) and the break time (start time of the break time and end time of the break time) in which the factory IDs of the production facility 131 to produce the product having the product ID to be processed coincide.

In step S1406, the information processing device 110 calculates the in-between time correction term. For example, the information processing device 110 calculates, from the production plan record of the product having the product ID to be processed, the period between the earliest start time and the latest end time of all processes, and, when the in-between times of the factory equipped with the production facility 131 to product the product occur at the same time (overlap) in the calculated period, calculates the overlapped time as the in-between time correction term. Note that the information processing device 110 may also, for example, refer to the production plan record of the product having the product having the product ID to be processed and, when the in-between times are overlapping in the period between the start time and the end time of each process, calculate the sum of the overlapping times as the in-between time correction term.

In step S1407, the information processing device 110 calculates the break time correction term. For example, the information processing device 110 calculates, from the production plan record of the product having the product ID to be processed, the period between the earliest start time and the latest end time of all processes, and, when the break times of the factory equipped with the production facility 131 to product the product overlap in the calculated period, calculates the overlapped time as the break time correction term. Note that the information processing device 110 may also, for example, refer to the production plan record of the product having the product having the product ID to be processed and, when the break times are overlapping in the period between the start time and the end time of each process, calculate the sum of the overlapping times as the break time correction term.

In step S1408, the information processing device 110 calculates the downtime correction term. For example, the information processing device 110 calculates, for each product of the product ID to be processed, the sum of the in-between time correction term and the break time correction term calculated in step S1406 and step S1407 as the downtime correction term. Note that the information processing device 110 associates the calculated downtime correction term with the product ID to be processed, and stores it in the auxiliary storage device 113.

As described above, according to the downtime correction term calculation processing, the downtime correction term is calculated for each product.

FIG. 15 is a diagram showing an example of the threshold candidate calculation processing.

In the threshold candidate calculation processing, the information processing device 110 performs the processing of step S1501 and step S1502 for each factory ID and for each product ID.

In step S1501, the information processing device 110 acquires the master information. For example, the information processing device 110 acquires, from the master table 600, the lead time initial threshold 604 of a record in which the factory ID 603 coincides with the factory ID of the factory equipped with the production facility 131 to produce the product having the product ID to be processed, and in which the flow ID 602 coincides with the flow ID of the flow of that product.

In step S1502, the information processing device 110 calculates the threshold candidate. For example, the information processing device 110 calculates the threshold candidate based on following (Formula 4). Here, the information processing device 110 reads, from the auxiliary storage device 113, the backlog correction term calculated regarding the merchandise category of the product having the product ID to be processed to be produced in the factory having the factory ID to be processed, reads the material arrival delay correction term calculated for each process in the production of that product, and reads the downtime correction term calculated regarding that product.

threshold candidate=backlog correction term+Σall-process material arrival delay correction term+downtime correction term (Formula 4)

As described above, according to the threshold candidate calculation processing, the threshold candidate is calculated for each product.

FIG. 16 is a diagram showing an example of the operational availability threshold calculation processing.

In the operational availability threshold calculation processing, the information processing device 110 performs the processing of step S1601 to step S1608 for each factory ID.

In step S1601, the information processing device 110 acquires the production plan information. For example, the information processing device 110 acquires, from the production plan table 500, all records in which the factory ID 507 coincides with the factory ID to be processed, the latest flag 510 is “TRUE” (“FALSE” in cases where a new plan is not created), and the calculation target date is (calculation target date 00:00:00<=start time 505, and end time 506<=calculation target date 23:59:59).

In step S1602, the information processing device 110 calculates the sum of the standard times. For example, the information processing device 110 calculates the sum of the standard times 511 of the records acquired in step S1601.

In step S1603, the information processing device 110 counts the quantity of the production facilities 131. For example, the information processing device 110 counts, from the production facility ID 508 of the records acquired in step S1601, the quantity of the production facilities 131 (production facility quantity) operating in the factory having the factory ID to be processed.

In step S1604, the information processing device 110 calculates the target value (example of initial threshold) as the target operational availability in the factory having the factory ID to be processed. For example, the information processing device 110 calculates the target value based on following (Formula 5).

target value=sum of standard time/(24 h×production facility quantity)×100 (Formula 5)

Note that the formula for calculating the target value is not limited to (Formula 5). Moreover, the target value is not limited to the value calculated by the information processing device 110, and may also be, for example, the value (so-called tacit knowledge) obtained by the worker reviewing the production plan information.

In step S1605, the information processing device 110 acquires the actual production information. For example, the information processing device 110 acquires, from the actual production table 300, all records in which the factory ID 307 coincides with the factory ID to be processed.

In step S1606, the information processing device 110 creates the daily production quantity distribution. For example, the information processing device 110 counts, from the product ID 301 of the records acquired in step S1605, the quantity of the products produced in the production facility 131 equipped in the factory having the factory ID to be processed on a daily basis, and thereby creates the daily production quantity distribution.

In step S1607, the information processing device 110 determines the production season. For example, the information processing device 110 determines to which production season among off season, normal season, and busy season the calculation target date corresponds in the daily production quantity distribution. Here, the information processing device 110 counts, from the product ID 501 of the records acquired in step S1601, the quantity (quantity X) of the products to be produced on the calculation target date in the production facility 131 equipped in the factory having the factory ID to be processed. The information processing device 110 determines that the calculation target date corresponds to an off season when the counted quantity X is smaller than the first quartile of the daily production quantity distribution. Moreover, the information processing device 110 determines that the calculation target date corresponds to a busy season when the counted quantity X is greater than the third quartile of the daily production quantity distribution. Moreover, the information processing device 110 determines that the calculation target date corresponds to a normal season when the counted quantity X is other than the above.

In step S1608, the information processing device 110 calculates the operational availability threshold. For example, the information processing device 110 calculates the operational availability threshold based on following (Formula 6). More specifically, the information processing device 110 calculates the operational availability threshold by using the coefficient (example of the correction term for correcting the initial threshold) that is set in correspondence with the determined production season. As the coefficient, for example, “0.5” is set for an off season, “0.75” is set for a normal season, and “0.9” is set for a busy season. Note that the coefficient may be stored in the master information storage unit 224 or the like, embedded (coded) in the calculation unit 216 or the like, or acquired from another computer.

operational availability threshold=target value×coefficient (Formula 6)

As described above, according to the operational availability threshold calculation processing, the operational availability threshold is calculated for each factory.

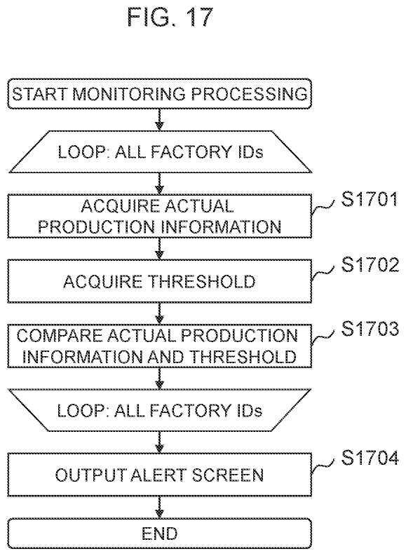

FIG. 17 is a diagram showing an example of the monitoring processing. The monitoring processing is executed at a suitable timing. The suitable timing may be a predetermined cycle, a predetermined time, timing instructed by a worker, or any other timing.

In the monitoring processing, the information processing device 110 performs the processing of step S1701 to step S1703 for each factory ID.

In step S1701, the information processing device 110 acquires the actual production information. For example, the information processing device 110 acquires, from the actual production table 300, all records in which the factory ID 307 coincides with the factory ID to be processed, and the monitoring target date is (monitoring target date 00:00:00<=start time 305, and end time 306<=monitoring target date 23:59:59). The monitoring target date is, for example, the execution date of the monitoring processing. Note that the information processing device 110 may also acquire the actual production information from at least one among the controller 132, the sensor 133, and the user terminal 135.

In step S1702, the information processing device 110 acquires the threshold. For example, the information processing device 110 acquires, from the lead time threshold table 810, all thresholds 815 (lead time thresholds) of the record in which the factory ID 813 coincides with the factory ID to be processed. Moreover, for example, the information processing device 110 acquires, from the operational availability threshold table 820, the threshold 823 (operational availability threshold) of the record in which the factory ID 821 coincides with the factory ID to be processed.

In step S1703, the information processing device 110 compares the actual production information and the threshold. For example, the information processing device 110 calculates, from the records acquired in step S1701, the lead time of the product produced on the monitoring target date in the production facility 131 equipped in the factory having the factory ID to be processed, calculates the difference between the calculated lead time and the lead time threshold of that product, and determines whether the calculated difference (deviation value) is within the range of the monitoring threshold. The information processing device 110 creates an alert screen of that product when it determines that the deviation value is not within the range of the monitoring threshold. The alert screen includes, for example, the information indicating the production facility 131 that produced that product. Moreover, the alert screen may also include other information such as the detailed information (process, flow and the like) of that product. Moreover, for example, the alert screen includes the actual production table 300 and/or the production plan table 500, and a record of the product in which an abnormality was detected may be displayed by being highlighted (for example, in a different color).

Moreover, information processing device 110 calculates, from the records acquired in step S1701, the operational availability in the factory having the factory ID to be processed, calculates the difference between the calculated operational availability and the operational availability threshold of that factory, and determines whether the calculated difference (deviation value) is within the range of the monitoring threshold. The information processing device 110 creates an alert screen indicating that the operational availability of that factory is inappropriate when it determines that the deviation value is not within the range of the monitoring threshold.

In step S1704, the information processing device 110 outputs the alert screen. For example, when the information processing device 110 creates an alert screen in step S1703, the information processing device 110 sends the alert screen to the site terminal 134 equipped in the factory related to the alert screen. The site terminal 134 displays, for example, the alert screen on a display.

According to the alert screen described above, for example, in a factory having a status in which the lead time of each product is increasing, it is possible to identify the production facility 131 that is encountering a defect, or identify the product in which an abnormality was initially detected. Consequently, for example, the production of products can be improved from a long-term perspective. Moreover, for example, since an alert is accurately output according to the status of the production facility 131, the worker can immediately notice an abnormality and take emergency measures.

According to this embodiment, it is possible to appropriately manage the production of products.

### (II) Supplementary Notes

The embodiment described above include, for example, the following subject matter.

While the foregoing embodiment explained a case of applying the present invention to a production management system, the present invention is not limited thereto, and may also be broadly applied to various other types of systems, devices, methods, and programs.

Moreover, while the foregoing embodiment explained the management of production in a plurality of factories, the present invention is not limited thereto. For example, production may also be managed in one factory. In the foregoing case, the factory ID and the processing for each factory are not required.

Moreover, while the foregoing embodiment explained a case of producing products of multiple types of merchandise categories in one factory, the present invention is not limited thereto. For example, products of one type of merchandise category may be produced in one factory. In the foregoing case, the merchandise category ID and the processing for merchandise category are not required.

Moreover, while the foregoing embodiment explained a case where one production facility 131 is in charge of one process, the present invention is not limited thereto. For example, one production facility 131 may also be in charge of a plurality of processes simultaneously.

Moreover, a part or all of the programs in the foregoing embodiment may be installed from a program source to a device such as a computer which realizes the information processing device 110 and the like. The program source may also be, for example, a program distribution server connected to a network or a computer-readable storage medium (for example, non-temporary storage medium). Moreover, in the foregoing explanation, two or more programs may be realized as one program, and one program may be realized as two or more programs. Moreover, in the foregoing explanation, two or more programs may be realized as one program, and one program may be realized as two or more programs.

Moreover, in the foregoing embodiments, the configuration of each table is merely an example, and one table may be divided into two or more tables or all or a part of two or more tables may be one table.

Moreover, while the foregoing embodiment explained a case of using an average value and a mode value as the statistical value, the statistical value is not limited to an average value and a mode value, and may also be a maximum value, a minimum value, a difference between the maximum value and the minimum value, a median value, a standard deviation or any other statistical value.

Moreover, in the foregoing embodiments, the output of information is not limited to a visual output on a display. The output of information may also be a sound output from a speaker, output to a file, printing on a paper medium or the like by a printing device, projecting on a screen or the like by a projector, or any other mode of output.

Moreover, in the foregoing explanation, information of programs, tables, files and the like which realize the respective functions may also be stored in a memory, a storage device such as a hard disk or an SSD (Solid State Drive), or a storage medium such as an IC card, an SD card, a DVD or the like.

The embodiment described above includes, for example, the following characteristic configurations.

(1)

A production management system (for example, production management system 100) which manages production of products in a production facility (for example, production facility 131), comprising: a first storage unit (for example, actual production information storage unit 221) which stores actual production information (for example, actual production table 300) including actual production values of the production of products in the production facility; a second storage unit (for example, 4M information storage unit 222, production plan information storage unit 223, external factor information storage unit 225) which stores status information (for example, 4M information, production plan information, external factor information) indicating a status of the production facility; a third storage unit (for example, master information storage unit 224) which stores master information (for example, master table 600) including a first threshold (for example, lead time initial threshold, target value) for detecting an abnormality in the production of products in the production facility; a calculation unit (for example, calculation unit 216) which calculates a correction term (for example, at least one among backlog correction term, material arrival delay correction term, and downtime correction term, coefficient of target value) according to the status of the production facility based on the status information stored in the second storage unit, and calculates a second threshold (for example, lead time threshold, operational availability threshold) in which the calculated correction term is set to a first threshold included in the master information stored in the third storage unit; and a detection unit (for example, detection unit 218) which detects an abnormality in the production of products in the production facility by using the actual production value included in the actual production information stored in the first storage unit and the second threshold calculated by the calculation unit according to the status of the production facility.

With the configuration described above, since the abnormality in the production of products in the production facility is detected by using the second threshold that has been set with a correction term according to the status of the production facility, for example, it is possible to appropriately output an alert according to the status of the production facility.

(2)

The first threshold is a threshold (for example, lead time threshold) for detecting an abnormality in a lead time of products produced in the production facility.

According to the foregoing configuration, for example, it is possible to detect an abnormality in the lead time according to the status of the production facility.

(3)

Products are produced in the production facility according to predetermined one or more processes (for example, see FIG. 9); the second storage unit stores, as the status information, production plan information (for example, record in which the latest flag 510 in the production plan table 500 is “FALSE”) of an initial plan in which are set a start time and an end time of each process of one or more products to be produced in the production facility, and production plan information (for example, record in which the latest flag 510 in the production plan table 500 is “TRUE”) of a new plan in which are set a start time and an end time of each process of one or more products including a backlog to be produced in the production facility; and the calculation unit: calculates a first time (for example, initial plan lead time) from a start time of a first process in the production of products to an end time of a final process in the production of the products based on the production plan information of the initial plan for each product to be produced in the production facility; calculates a second time (for example, new plan lead time) from a start time of a first process in the production of products to an end time of a final process in the production of the products based on the production plan information of the new plan for each product to be produced in the production facility; and calculates a correction term according to the status of the production facility by using the first time and the second time calculated for the products to be produced in the production facility (for example, for each factory, for each product merchandise category, or for each product) (for example, see FIG. 12).

With the configuration described above, since the second threshold is calculated by setting a correction term for the backlog to the first threshold, for example, it is possible to detect an abnormality in the lead time according to the backlog.

(4)

Products are produced in the production facility according to predetermined one or more processes (for example, see FIG. 9); the second storage unit stores, as the status information, actual material arrival information (for example, record of the 4M table 400) which indicates an arrival time that a material arrived in each process of one or more products to be produced in the production facility, and production plan information (for example, record of the production plan table 500) of a plan which specifies a start time of each process of one or more products to be produced in the production facility; and the calculation unit: calculates, for each product to be produced in the production facility and for each process of the product, when the start time of the production plan information stored in the second storage unit is later than the arrival time of the actual material arrival information stored in the second storage unit, a time obtained by subtracting the start time from the arrival time as an arrival delay time; and calculates a correction term according to the status of the production facility by using the calculated arrival delay time (for example, for each factory, for each flow, or for each process) (for example, see FIG. 13).

With the configuration described above, since the second threshold is calculated by setting a correction term of the material arrival delay time to the first threshold, for example, it is possible to detect an abnormality in the lead time according to the material arrival delay.

(5)

The second storage unit stores, as the status information, non-operating time information (for example, record of the external factor table 700) which indicates a non-operating time that the production facility is not operated, and production plan information (for example, record of the production plan table 500) of a plan which specifies a production time (for example, start time 505 and end time 506) of each process of one or more products to be produced in the production facility; and the calculation unit: calculates, for each product to be produced in the production facility, a time in which a non-operating time of the non-operating time information stored in the second storage unit and a production time of the production time information stored in the second storage unit overlap as downtime; and calculates a correction term according to the status of the production facility by using the calculated downtime (for example, for each product) (for example, see FIG. 14).

With the configuration described above, since the second threshold is calculated by setting a correction term of the downtime to the first threshold, for example, it is possible to detect an abnormality in the lead time according to the shutdown of the production facility.

(6)

The actual production information stored in the first storage unit includes information (for example, start time 305 and end time 306) capable of calculating the lead time of the products produced in the production facility; and the calculation unit, when the calculated second threshold is smaller than a minimum value of the lead time calculated from the actual production information stored in the first storage unit, sets the minimum value of the lead time as the second threshold (for example, see FIG. 11).

According to the foregoing configuration, for example, it is possible to avoid a situation where an unfeasible threshold is set.

(7)

The first threshold is a threshold (for example, operational availability threshold) for detecting an abnormality in an operational availability of the production facility; the second storage unit stores, as the status information, production plan information (for example, record of the production plan table 500) indicating a plan which specifies one or more products to be produced on a predetermined day in the production facility; the calculation unit: counts, based on the actual production information stored in the first storage unit, a quantity of the products produced in the production facility as an actual production quantity on a daily basis; counts, as a planned quantity, a quantity of the products produced on the predetermined day from the production plan information stored in the second storage unit; and determines to which production season among a plurality of predetermined production seasons (for example, off season, normal season, busy season) the predetermined day corresponds based on the counted actual production quantity and the counted planned quantity, and calculates a second threshold by multiplying a coefficient that is set according to the determined production season by a target value of the operational availability of the production facility on the predetermined day (for example, see FIG. 16).

According to the foregoing configuration, for example, it is possible to detect an abnormality in the operational availability according to the status of the production facility.

Moreover, the foregoing configurations may be suitably changed, rearranged, combined or omitted to the extent that such change, rearrangement, combination or omission does not exceed the subject matter of the present invention.

Items included in a list according to a format of “at least one among A, B, and C” should be understood to mean (A), (B), (C), (A and B), (A and C), (B and C) or (A, B, and C). Similarly, items included in a list according to a format of “at least one among A, B, or C” should be understood to mean (A), (B), (C), (A and B), (A and C), (B and C) or (A, B, and C).

### REFERENCE SIGNS LIST

100 . . . production management system, 110 . . . information processing device, 120 . . . information storage device, 131 . . . production facility.

1. A production management system which manages production of products in a production facility, comprising:
a first storage unit which stores actual production information including actual production values of the production of products in the production facility;
a second storage unit which stores status information indicating a status of the production facility;
a third storage unit which stores master information including a first threshold for detecting an abnormality in the production of products in the production facility;
a calculation unit which calculates a correction term according to the status of the production facility based on the status information stored in the second storage unit, and calculates a second threshold in which the calculated correction term is set to a first threshold included in the master information stored in the third storage unit; and
a detection unit which detects an abnormality in the production of products in the production facility by using the actual production value included in the actual production information stored in the first storage unit and the second threshold calculated by the calculation unit according to the status of the production facility.

2. The production management system according to claim 1, wherein:
the first threshold is a threshold for detecting an abnormality in a lead time of products produced in the production facility.

3. The production management system according to claim 2, wherein:
products are produced in the production facility according to predetermined one or more processes;
the second storage unit stores, as the status information, production plan information of an initial plan in which are set a start time and an end time of each process of one or more products to be produced in the production facility, and production plan information of a new plan in which are set a start time and an end time of each process of one or more products including a backlog to be produced in the production facility; and
the calculation unit:
calculates a first time from a start time of a first process in the production of products to an end time of a final process in the production of the products based on the production plan information of the initial plan for each product to be produced in the production facility;
calculates a second time from a start time of a first process in the production of products to an end time of a final process in the production of the products based on the production plan information of the new plan for each product to be produced in the production facility; and
calculates a correction term according to the status of the production facility by using the first time and the second time calculated for the products to be produced in the production facility.

4. The production management system according to claim 2, wherein:
products are produced in the production facility according to predetermined one or more processes;
the second storage unit stores, as the status information, actual material arrival information which indicates an arrival time that a material arrived in each process of one or more products to be produced in the production facility, and production plan information of a plan which specifies a start time of each process of one or more products to be produced in the production facility; and
the calculation unit:
calculates, for each product to be produced in the production facility and for each process of the product, when the start time of the production plan information stored in the second storage unit is later than the arrival time of the actual material arrival information stored in the second storage unit, a time obtained by subtracting the start time from the arrival time as an arrival delay time; and
calculates a correction term according to the status of the production facility by using the calculated arrival delay time.

5. The production management system according to claim 2, wherein:
the second storage unit stores, as the status information, non-operating time information which indicates a non-operating time that the production facility is not operated, and production plan information of a plan which specifies a production time of each process of one or more products to be produced in the production facility; and
the calculation unit:
calculates, for each product to be produced in the production facility, a time in which a non-operating time of the non-operating time information stored in the second storage unit and a production time of the production time information stored in the second storage unit overlap as downtime; and
calculates a correction term according to the status of the production facility by using the calculated downtime.

6. The production management system according to claim 2, wherein:
the actual production information stored in the first storage unit includes information capable of calculating the lead time of the products produced in the production facility; and
the calculation unit, when the calculated second threshold is smaller than a minimum value of the lead time calculated from the actual production information stored in the the first storage unit, sets the minimum value of the lead time as the second threshold.

7. The production management system according to claim 1, wherein:
the first threshold is a threshold for detecting an abnormality in an operational availability of the production facility;
the second storage unit stores, as the status information, production plan information indicating a plan which specifies one or more products to be produced on a predetermined day in the production facility;
the calculation unit:
counts, based on the actual production information stored in the first storage unit, a quantity of the products produced in the production facility as an actual production quantity on a daily basis;
counts, as a planned quantity, a quantity of the products produced on the predetermined day from the production plan information stored in the second storage unit; and
determines to which production season among a plurality of predetermined production seasons the predetermined day corresponds based on the counted actual production quantity and the counted planned quantity, and calculates a second threshold by multiplying a coefficient that is set according to the determined production season by a target value of the operational availability of the production facility on the predetermined day.

8. A production management method in a production management system which manages production of products in a production facility, wherein the production management system comprises:
a first storage unit which stores actual production information including actual production values of the production of products in the production facility;
a second storage unit which stores status information indicating a status of the production facility; and
a third storage unit which stores master information including a first threshold for detecting an abnormality in the production of products in the production facility;
wherein the production management method includes:
a step of a calculation unit calculating a correction term according to the status of the production facility based on the status information stored in the second storage unit, and calculating a second threshold in which the calculated correction term is set to a first threshold included in the master information stored in the third storage unit; and
a step of a detection unit detecting an abnormality in the production of products in the production facility by using the actual production value included in the actual production information stored in the first storage unit and the second threshold calculated by the calculation unit according to the status of the production facility.
